(19) United States
(12) Patent Application Publication
(10) Pub. No.: US 2008/0303739 A1
(43) Pub. Date: Dec. 11, 2008

(54) INTEGRATED MULTI-BEAM ANTENNA RECEIVING SYSTEM WITH IMPROVED SIGNAL DISTRIBUTION

(76) Inventors: Thomas Edward Sharon, Duluth, GA (US); Dedi David Haziza, San Jose, CA (US)

Correspondence Address: NIXON PEABODY, LLP, 401 9TH STREET, NW, SUITE 900, WASHINGTON, DC, 20004-2128, US

(21) Appl. No.: 12/135,099

(22) Filed: Jun. 6, 2008

Related U.S. Application Data
(60) Provisional application No. 60/942,635, filed on Jun. 7, 2007.

(51) Int. Cl. H01Q 1/00

(52) U.S. Cl. 343/876

(57) ABSTRACT

An integrated multi-beam antenna receiving system controls signal flow to a set of frequency translation devices in order to provide the required signals requested by Integrated Receiver Decoder units (IRDs, or set-top-boxes) within the home. The receiving system is compatible with legacy IRDs, or can support delivery of the requested signals in digital format allowing single coaxial cable or twisted pair delivery into the home. The system supports satellite reception from a mixed constellation of Direct Broadcast Satellites (DBS) and Fixed Satellite Service platforms operating in multiple frequency bands.

### CROSS-REFERENCE TO RELATED APPLICATIONS

This Application claims priority from U.S. Provisional Application Ser. No. 60/942,635 filed on Jun. 7, 2007, the entire disclosure of which is incorporated herein by reference.

### BACKGROUND

1. Field of the Invention

The present invention relates to an integrated antenna and receiving system, consisting of a multi-beam antenna aperture, a low noise receiving system, frequency translation modules, and digital demodulators which provide multiple satellite transponder channels to set-top-boxes within a home.

2. Description of the Related Art

Satellite broadcasting of television programming has evolved from a distribution source consisting of a single Ku-band Direct Broadcasting Satellite (DBS) to multiple satellites operating in both the DBS (officially called BSS) service as well as the systems typically used for two-way satellite communications (FSS). Recently additional satellites operating in higher frequency bands (Ka FSS) have also been added. It is anticipated that in the future new higher frequency satellites operating in the Ka BSS band (17 GHz) will also be used to provide the additional capacity needed to support additional HDTV programming delivery. Satellite television systems typically support up to eight television sets within the home with independent channel selection, although the majority of systems have four sets or fewer.

FIG. 1 illustrates the constellation of satellites that are involved with the distribution of television programming over the United States. The satellites are all located within the geostationary arc at an altitude above the earth at which they maintain a constant overhead position for viewing from a fixed site on the earth. The satellites in FIG. 1 are grouped into four categories, illustrated by four different arcs, depending on their frequency band (Ku (˜12 GHz) or Ka (˜20 GHz)) and their operation as a broadcast (one-way) service (BSS in FIG. 1) or in the band designed for two-way service (FSS). The arcs do not represent different altitudes, but rather grouping of the satellites. Satellites indicated with asterisks are either approved or proposed, while those without an asterisk are already in orbit. As seen from FIG. 1, future deployments would add some capacity in the Ku BSS, KU FSS bands, and much new capacity at the Ka BSS band.

FIG. 2 illustrates a current system of the related art, which employs three Ku DBS satellites at 101° W, 110° W., and 119° W, whose signals are received by antenna 200. To enable reception of signals from the three satellites, antenna 200 has multiple feed-horns 205, 210 and 215, each attached to a corresponding receiving units (Low Noise Block—LNBs encased in box 220) to process the satellite signal into a format which can be delivered over coaxial cables 225 into the home. Each satellite operates with two independent polarization channels, requiring six single or three dual LNB units within the receiving system. The combination of antenna, feed horns, LNBs, and distribution switches located on the antenna is collectively referred to as the Outdoor Unit. (ODU).

FIG. 3 illustrates a more recent system, sometimes referred to as 5-beam KuKa deployment. In the deployment of FIG. 5, two additional orbital slots (at 103° W, and 99° W) have been equipped with Ka FSS band satellites operating in both the 19.7-20.2 GHz and 18.3-18.8 GHz band. Since both bands employ dual polarization, a total bandwidth of 4 GHz is provided within the transmissions of these Ka band satellites. This deployment augments the Ku BSS capacity of the satellites shown in FIG. 2, which employs 46 transponders of 24 MHz each. In total, approximately 5 GHz of bandwidth is available from the satellite constellation shown in FIG. 3. As with the installation of FIG. 2, a single “dish” antenna 300 is used to collect the transmitted signal and reflect it towards the LNBF's (Low Noise Block Feedhorns) 305, 310 and 315. This total does not include any additional future capacity which might be available to service providers in other Ku BSS or Ka BSS bands as shown in FIG. 1.

FIG. 4 illustrates a prior art system which employs three Ku DBS satellites and also selects selective programming from one other Ku FSS satellite. Bandwidth and other limitations prevent the use of more than one Ku FSS satellite at a time in conjunction with the Ku DBS satellites of this configuration. The antenna system shown in FIG. 4 utilizes a dish 400 projecting onto four separate feed horns and associated LNBs (together indicated at 410) for reception of the satellite television programming. The feed horn associated with the Ku FSS satellite must be “boresighted” by tilting the antenna to align the linear polarization of the KU FSS satellite signal with the receiving feed horn. Since the polarization varies as the selected satellite varies across the geostationary arc, it is obvious that this severe limitation greatly complicates the implementation of the mixed Ku BSS/FSS system.

FIG. 5 illustrates two frequency plans by which these signals are delivered into the home over four coaxial cables. Each cable carries 1.5 GHz of bandwidth, providing a total of 6 GHz bandwidth within the existing infrastructure. In FIG. 5 Plan A illustrates transmission of signals from 48 transponders (3×16) over a single cable. Each transponder caries a bandwidth of 24 MHz, and the transponders are divided into three bands, 16 transponders in each band of 250 MHz-750 MHz, 950 MHz-1450 MHz, and 1650 MHz-2150 MHz. Plan B shows 32 transponders carried over a single coaxial cable carrying 1 GHz. The 32 transponders are divided into two groups of 16 transponders each, allocated to two bandwidth 950 MHz-1450 MHz and 1650 MHz-2150 MHz.

FIG. 6 illustrates the complete ODU architecture in which the received right-hand circularly polarized (RCP) and left-hand circularly polarized (LCP) signals from each feed horn (600-606) pass through separate low-noise amplifiers (LNAs 610-624), followed by a frequency down-conversion stage 630 using a common local oscillator (640-646) for the associated dual polarizations received by each feed horn. These down-converted signals are then rearranged in frequency (“stacked”) by frequency translation 650, so that each of four cables can carry the required 1.5 GHz bandwidth shown in FIG. 5. Since each Integrated Receiver-Decoder (IRD) can independently select its own signal, a non-blocking IF (intermediate Frequency) switch 660 (“4×4 multiswitch”) follows, which allows each IRD to receive its selected transponder carrying the program of interest.

FIG. 7 illustrates a corresponding architecture of another prior art system, which receives signals from three Ku DBS satellites and one Ku FSS satellite. A separate feed horn network configuration is required for each of the Ku FSS satellite used to augment the Ku BSS capacity, although FIG. 7 illustrates only one Ku FSS feed horn 700 with its associated signal amplifiers 715 and 720 for the vertically and horizontally polarized signals. The frequency translation unit 740 in this case “stacks” opposite polarizations in the 950-1450 MHZ and 1650-2150 MHz bands, providing 1 GHz of bandwidth over each coaxial cable into the home. In the this system, the 4×4 multiswitch 750 is usually located inside the home and acts as a distribution point for switching the appropriate transponder to each IRD.

It can be seen that the addition of one Ku DBS satellite into either the system of FIG. 6 or FIG. 7 would result in a requirement to change the four cable architecture shown to accommodate the additional bandwidth. For example, a new satellite has been authorized for operation at 86.5° W. in addition to the satellites shown in FIG. 6. To access the new programming associated with this future asset, a new ODU and a change in the cabling will be necessary to accommodate the additional bandwidth. It would clearly be desirable for the ODU to be able to accommodate additional future orbital slot capacity without changing the infrastructure in every home accessing this new programming.

In addition, the incorporation of future satellites operating in the Ka BSS band (17.2-17.7 GHz) cannot be accommodated by the frequency plan of FIG. 5. An alternative frequency plan is required to facilitate services in this new band.

If future Ku FSS satellite services are required at new orbital positions (such as 77V), it would also be desirable to accommodate this service without having to design and install a new specialized ODU for this purpose.

In the future, as the number of satellite positions and associated bandwidth continue to increase, it would clearly be desirable to have all of the satellite programming carried over a single coaxial wire, or twisted pair wire into the home. If this signal is of a digital nature, it could then be distributed over new means such as wireless local area network distribution, or existing power line distribution within a home.

Whatever future satellite capacity additions are implemented, it would be advantageous if the signal distribution method could be compatible with existing legacy IRDs, so that these units and the associated home wiring would not have to be changed.

It can be seen, then, that there is a need in the art for an integrated multi-satellite receiving system which can be expanded to accommodate new orbital assets in the Ku BSS, Ku FSS and Ka BSS bands. This system should provide compatibility with existing legacy IRDs, but also accommodate simplified single cable wiring into the home for new installations. As new satellite assets are brought into service, it is desirable for the system to be able to access these assets without the need for an additional installer visit.

### SUMMARY

To minimize the limitations of the prior art, and to minimize other limitations that will become apparent upon reading and understanding the present specification, the present invention discloses a method and apparatus for an integrated multi-beam satellite receiving system which can accommodate future orbital assets without changes to the physical infrastructure installed. The present invention can also accommodate a single coaxial cable delivery of multiple satellite signals to the home for new users. It can further minimize the number and complexity of ODU components by delivering only the desired transponders selected by the IRDs rather than the present method which delivers the total bandwidth of all orbital assets to each IRD.

A system in accordance with the present invention comprises a dual-polarized multi-beam antenna with either linear or circularly polarized feed elements, a plurality of low-noise amplifiers attached to each feed element, and rf switching assembly which selects the desired satellite transponders which contain the requested programming, an appropriate number of LNBs based on the number of receiving stations in the home (television sets or DVRs). The signals can be delivered in a manner that is compatible with existing IRDs. For new installations, an additional feature is provided by which all selected signals can be delivered over a single coaxial cable or twisted pair wire for further distribution within the home.

While in the prior art the number of LNBF's must equal the number of satellites, according to the invention the number of LNB's equals the number of receivers in the home. Thus, while in the prior art a system having four LNB's and four IRD's is limited to reception from four satellites, such a system constructed according to the invention may receive signals from more than four satellites and may still feed the signal to each of the four IRD's.

Other features and advantages are inherent in the system and method claimed and disclosed, or will become apparent to those skilled in the art from the following detailed description and its accompanying drawings.

### BRIEF DESCRIPTION OF THE DRAWINGS

FIG. 1 illustrates the constellation of geostationary satellites presently employed in providing broadcast television services to the United States, and identifies future assets which have been authorized by regulatory bodies or proposed for operation;

FIG. 2 illustrates one existing system providing programming from three orbital locations;

FIG. 3 illustrates a more recent system providing programming from five orbital positions in both the Ku BSS and KA FSS bands;

FIG. 4 illustrates another operational system of the related art which delivers programming from three Ku BSS orbital positions and one selected Ku FSS position;

FIG. 5 illustrates the frequency plan for signals delivering the programming into the home over coaxial cables;

FIG. 6 illustrates the receiving system of the related art which processes the signals from the five orbital positions shown in FIG. 3;

FIG. 7 illustrates the receiving system of the related art which processes the signals from the four orbital positions shown in FIG. 4;

FIG. 8 illustrates an embodiment of a system architecture according to the present invention;

FIG. 9 illustrates an embodiment of a digital processing module for providing single wire interface to home IRDs;

FIG. 10 illustrates an embodiment in accordance with the present invention which extends the available satellite capacity of the Ku BSS system architecture;

FIG. 11 illustrates an embodiment in accordance with the present invention which extends the available satellite capacity of the Ku BSS/Ka FSS system architecture in a method compatible with legacy IRDs;

FIG. 12 illustrates an embodiment in accordance with the present invention which extends the available satellite capacity of the Ku BSS/Ku FSS system architecture in a method compatible with legacy IRDs;

FIG. 13 illustrates a block diagram of an embodiment of an electronic polarization rotation module in accordance with the present invention for use with Ku FSS signals;

FIG. 14 illustrates an embodiment in accordance with the present invention which extends the available satellite capacity of the Ku BSS/Ka FSS system architecture in a method providing signal distribution into the home over a single coaxial cable with new IRDs;

FIG. 15 illustrates an embodiment in accordance with the present invention which extends the available satellite capacity of the Ku BSS/Ku FSS system architecture in a method providing signal distribution into the home over a single coaxial cable with new IRDs;

### DETAILED DESCRIPTION

### Overview

In the following description, reference is made to the accompanying drawings which show, by way of illustration, several embodiments of the present invention. It is understood that other embodiments may be utilized without departing from the scope of the present invention.

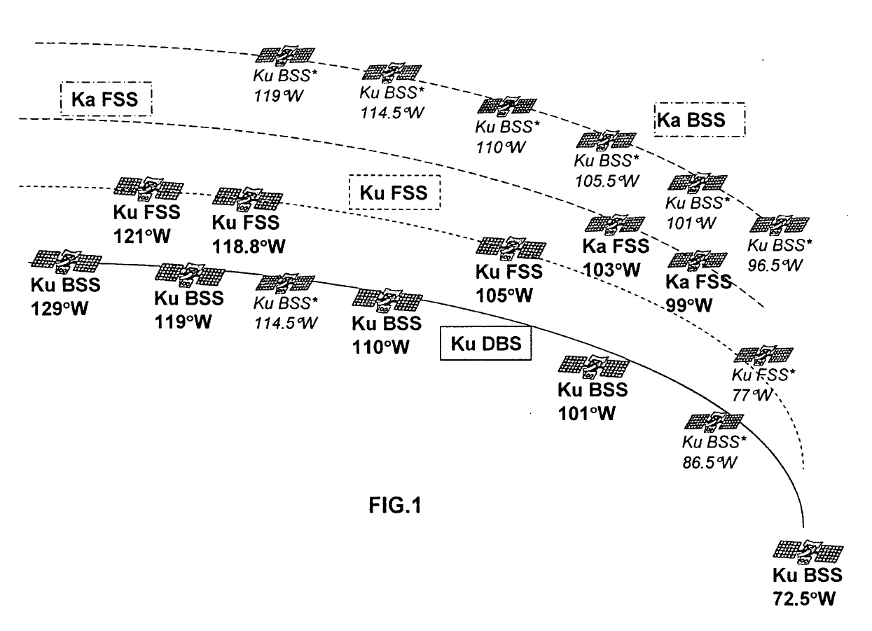

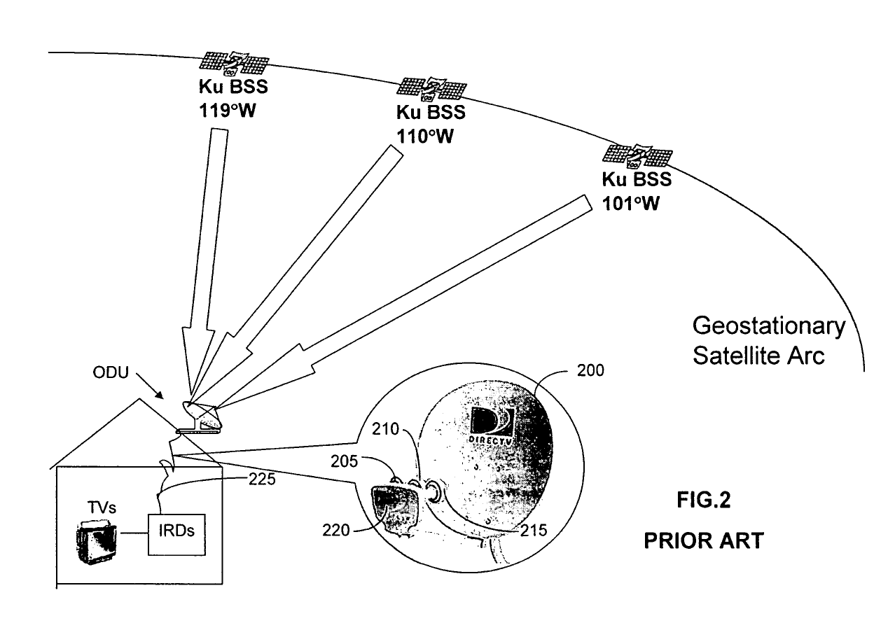

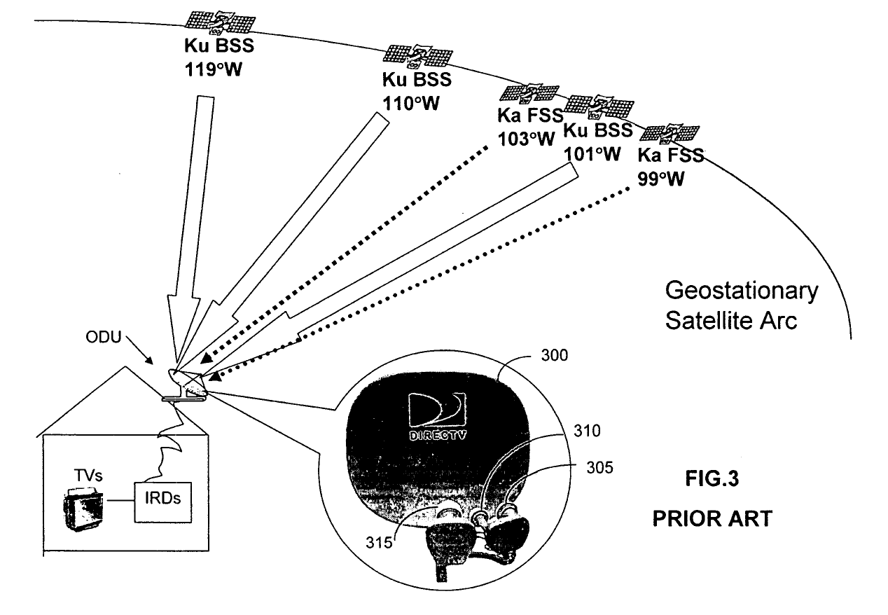

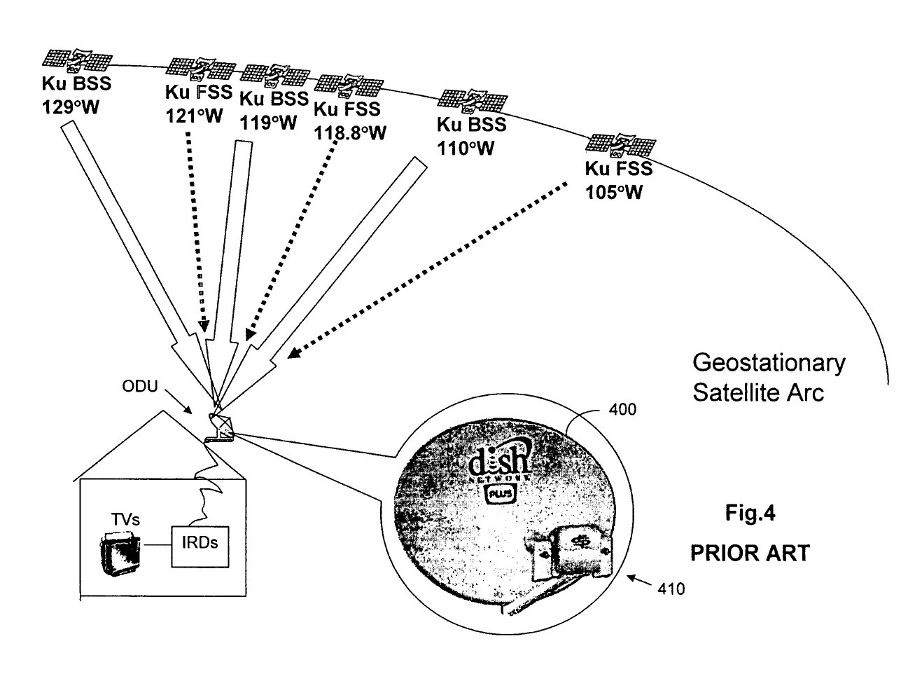

As illustrated in FIGS. 1-5, there are several architectures employed by the related art to receive satellite signals from direct broadcast satellites and deliver video content into the home. These systems may be categorized as follows: (1) FIG. 2 shows an expanded Ku BSS architecture in which the signals are delivered from up to three orbital locations operating in the original 12.2-12.7 GHz BSS frequency bands. (2) FIG. 3 shows a hybrid Ku BSS/Ka FSS architecture in which the video signals are delivered from three Ku BSS and two Ka FSS orbital locations. (3) FIG. 4 shows a hybrid Ku BSS/Ku FSS architecture in which the video signals are delivered from three Ku BSS and one Ku FSS orbital locations. Generally there is more than one satellite broadcasting from each orbital location, and some satellites may employ spot beam technology while others broadcast their signals more or less uniformly over CONUS.

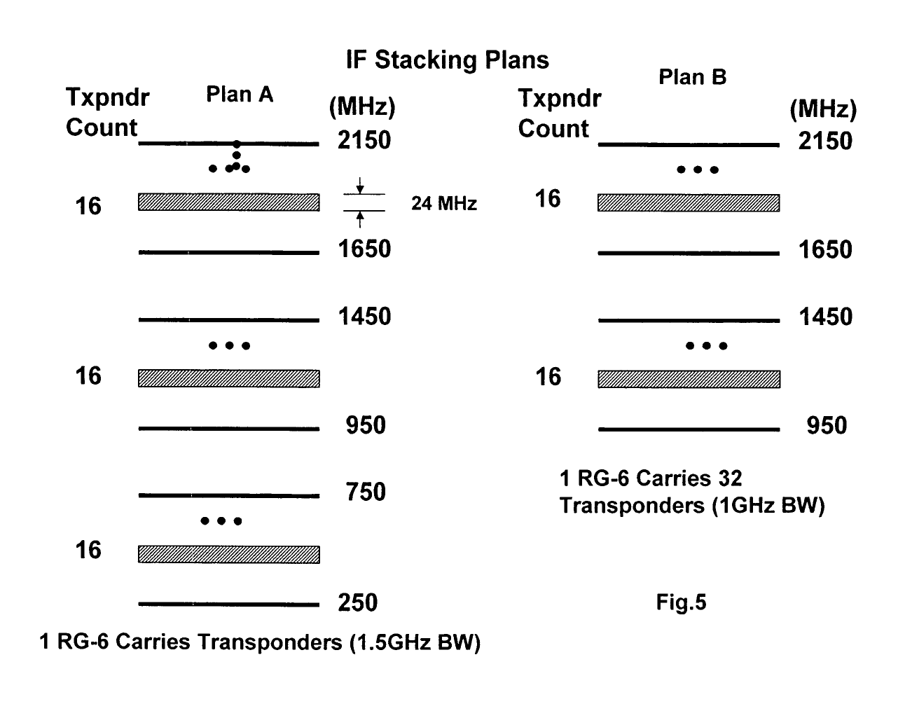

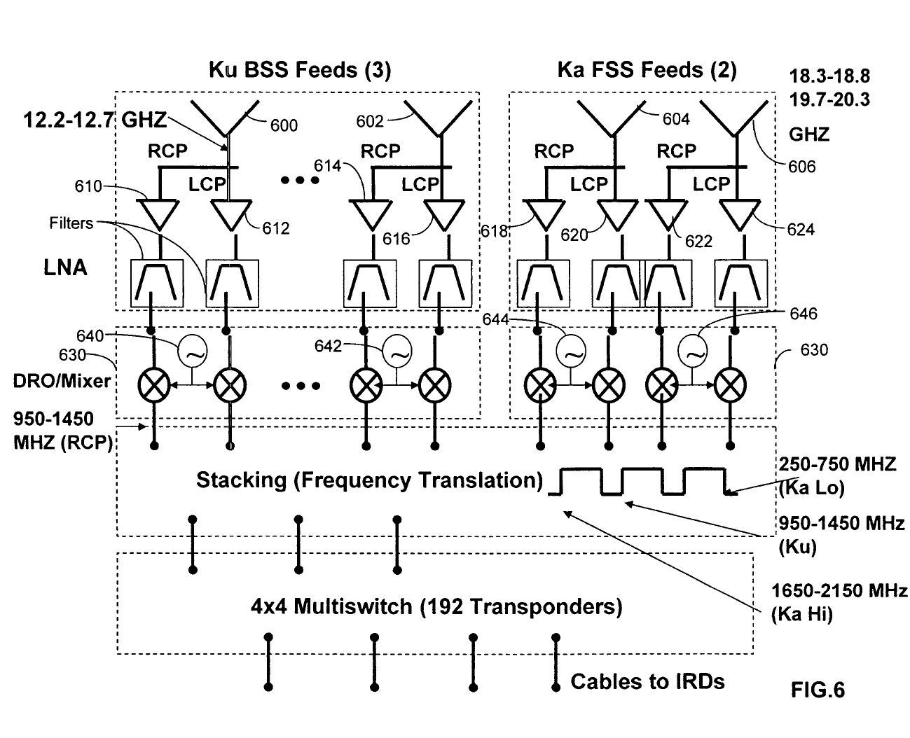

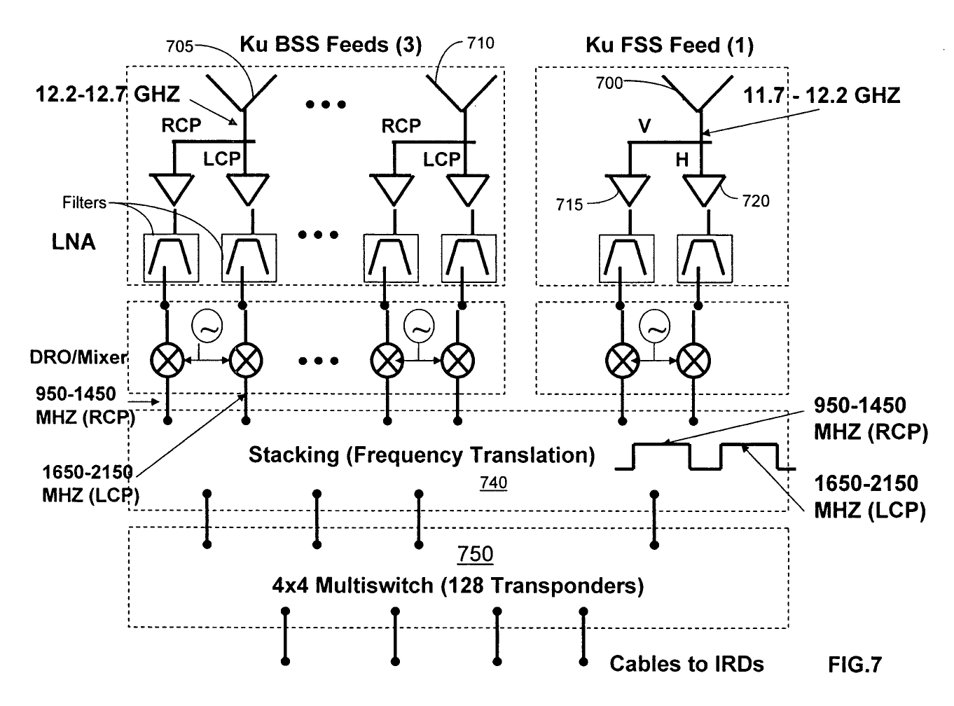

The related art signal distribution and processing systems route signals from dual polarized feed horns into individual LNBs as shown in FIGS. 6-7, which downconvert the transponder channels and then rearrange them into a “stacked” frequency plan as shown in FIG. 5. In this architecture, there is basically one feed horn and one dual LNB for each orbital location. The current implementation shown in FIGS. 3&5 totally utilizes the available IF bandwidth capacity illustrated in FIG. 5, eliminating the possibility for adding new satellites at different orbital locations without changing the complete antenna/ODU and the wiring configuration into the home.

The present invention allows for a significant simplification of the receiving system while allowing additional orbital locations to be added without changing the antenna/ODU or the pre-existing cabling. Further, the present invention provides for compatibility with legacy IRDs within the home in existing customer locations, as well as offering a single wire interface into the home for new IRDs which employ a digital rather than analog interface.

### System Diagram

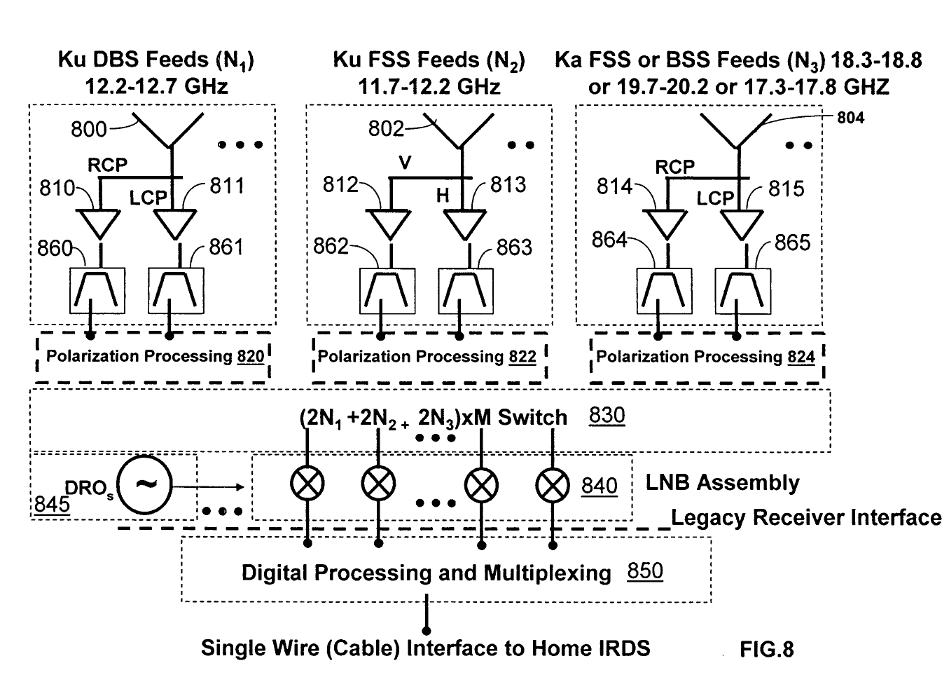

FIG. 8 illustrates a system diagram according to an embodiment of the present invention. The feed elements are grouped by frequency band into three major sets: (1) Ku BSS dual polarized feeds 800 which operate in the 12.2-12.7 GHz band; (2) Ku FSS dual polarized feeds 802 which operate in the 11.7-12.2 GHz band; (3) Ka FSS or Ka BSS dual polarized feeds 804 which operate in the 18.3-18.8 GHz band, 19.7-20.2 GHz band, or 17.3-17.8 GHz band. The feed elements may be based on either linear or circularly polarized radiating elements. Both polarizations corresponding to an orbital location are amplified by a low noise rf amplifier 810-815 to set the noise figure of the system, passed through filters 860-865, and then are inputs to a polarization processing module 820, 822, 824, which selects the final polarizations to be processed. Satellite signals received by radiating elements based on linear polarization can be combined by a single quadrature hybrid to produce dual circularly polarized radiation patterns, or they can be combined using more complicated modules such as polarization rotators (for Ku FSS operation, the selected orbital location must be corrected aligned with feed polarization for proper operation). The latter requirement presently restricts the related art to the use of only a single Ku FSS satellite, which must be located at the boresight of the multibeam antenna. In the present invention, the resultant polarization of each orbital location can be independently adjusted by use of the polarization network attached to the corresponding feeds.

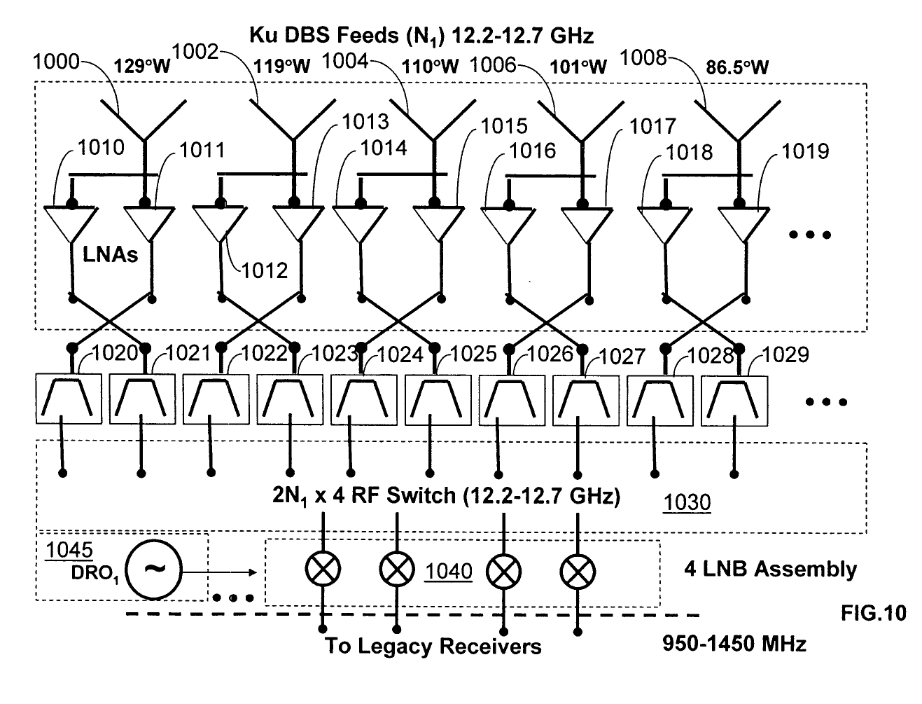

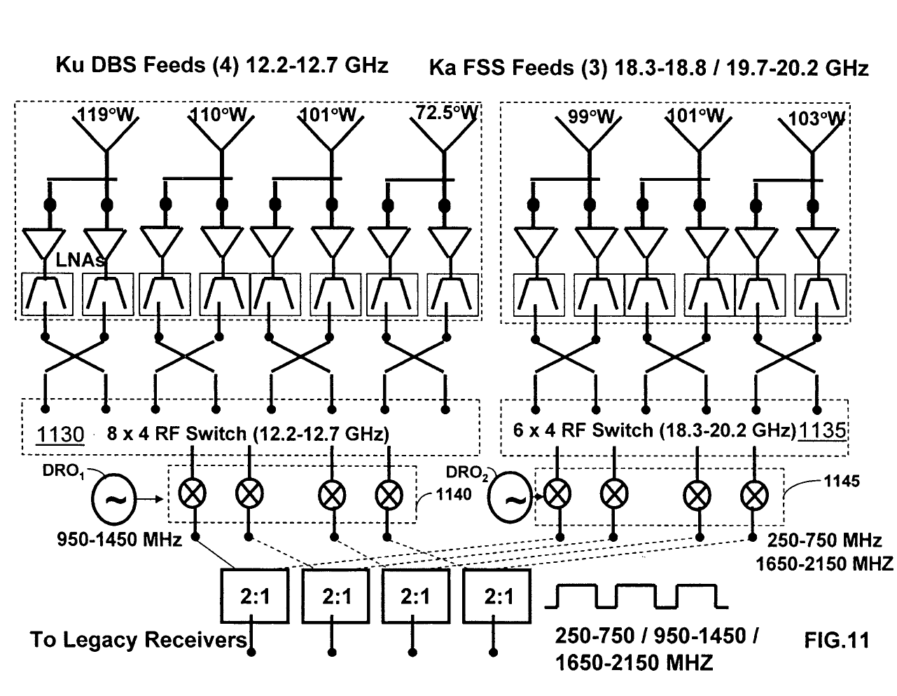

The number of feeds can be expanded arbitrarily in the present invention with the addition of only the front end rf components preceding the LNB assembly. The selected video signals (by transponder) are then routed by an RF switch 830 into the LNB assembly 840. The RF switch 830 can either operated over the entire bandwidth comprised by the various feeds (see, e.g., FIG. 10), or the individual feeds can be grouped by operating band and the switching accomplished within sub-bands (see, e.g., FIG. 11).

Feed elements can be installed in the antenna to anticipate the future use of a new orbital slot, such as 86.5° W for Ku BSS, or 101° W. for Ka BSS (new direct broadcast band approved by the FCC for use after April 2007).

The RF switch 830 can be “non-blocking”, meaning that any of the input signals can be selected at any of the outputs ports. It is clear that this capability eliminates the need for the current IF multiswitch employed in the related art.

Multiple downconverters can be used within the LNB assembly, by utilizing local oscillators such as Dielectric Resonator Oscillators DRO's 845, to generate the desired IF signal frequency band to match the receiver IF interface selected. The number of LNB's may be selected according to the desired number of IRD's. If further signal processing is provided at the digital level, a common IF frequency band (such as 950-1450 MHz) can be selected for all the downconverters.

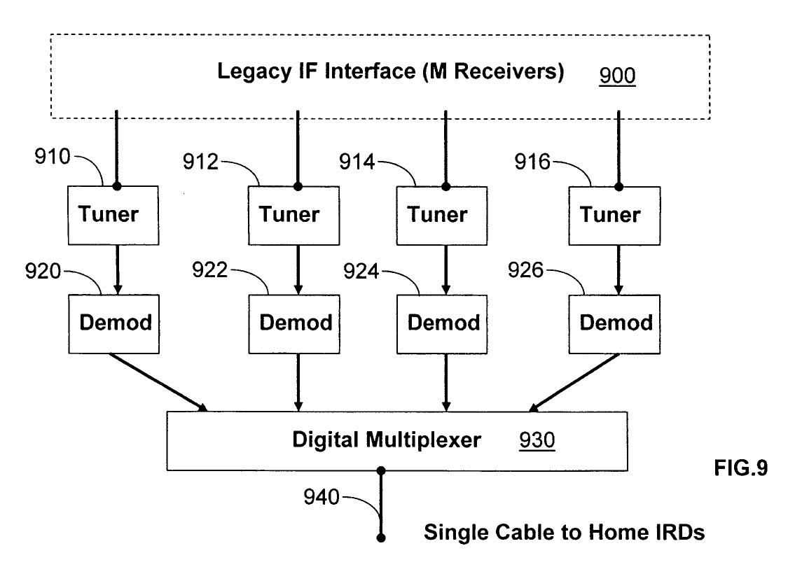

FIG. 9 further illustrates the operation of the optional single wire digital interface that could be replacing the digital processing and multiplexing part 850, shown in FIG. 8. After downconversion (shown in FIG. 8), the transponder signals are routed to a tuner 910-916 which establishes baseband signals (“I” and “Q”) for further processing. A typical tuner output signal is at “zero IF”, or 0-24 MHz operating bandwidth. The “I” and “Q” outputs of the tuners can be further processed by an integrated demodulator 920-926 providing digital signals outputs corresponding to either DSS, DVB-S, or DVBN-S2 industry video standards. Once the digital video streams have been extracted, they can be digitally multiplexed (930) and routed into the home on a single coaxial cable or twisted pair 940, greatly simplifying the installation process.

### An Embodiment for Expanded Ku BSS Architecture

FIG. 10 is a system block diagram for an expanded Ku BSS receiving system which expands the number of orbital locations which can be processed beyond the related art implementations of three locations. For purposed of illustration, two additional locations have been added at 129° W and 86.5° W, although the number of slots can be expanded arbitrarily at pre-determined locations. Each of the five horn feeds 1000-1008 receives a corresponding signal from one of the five satellites. Each of the horns 1000-1008 is coupled to two corresponding LNA 1010-1019 for processing the two polarized signals. The signal from each LNA is then passed through a filter 1020-1029, and the outputs of all of the filters are input to an RF switch. For the example shown, a 10:4 non-blocking RF switch 1030 can be used to select the desired transponder containing the video content requested by four independent IRDs. That is, in this example the number of inputs is selected as twice the number of horn feeds, while output is selected as the conventional four, so as to utilize legacy receivers. Of course, other arrangements may be selected. A single local oscillator (e.g., DRO 1045) is sufficient to drive four mixer assemblies 1040, producing IF outputs in the 950-1450 MHz frequency band. All legacy receivers have the ability to process video signals presented in this IF band, so it is a convenient choice although other IF bands could be selected.

### An Embodiment for Expanded Ku BSS/Ka FSS Architecture

FIG. 11 is a system block diagram for an expanded Ku BSS/Ka FSS receiving system which expands the number of Ku BSS orbital locations to four, and the number of Ka FSS (or Ka BSS) locations to three. For purpose of illustration, two additional locations have been added at 72.5° W for Ku BSS and 101° W for Ka BSS, although the number of slots can be expanded arbitrarily at pre-determined locations. For the example shown, two separate non-blocking RF switches, 1130 and 1135, can be used to select the desired transponder containing the video content requested by four independent IRDs. The bandwidth of the RF switches required is modest, but requires that two local oscillators (DRO₁ and DRO₂) with separate mixer assemblies, 1140 and 1145, be used to produce the four IF outputs in the 250-750 MHz, 950-1450 MHz, and 1650-2150 MHz frequency bands. Legacy receivers have the ability to process “stacked” Ku/Ka video signals presented in this IF band, so it is a convenient choice although other IF bands could be selected.

### An Embodiment for Expanded Ku BSS/Ku FSS Architecture

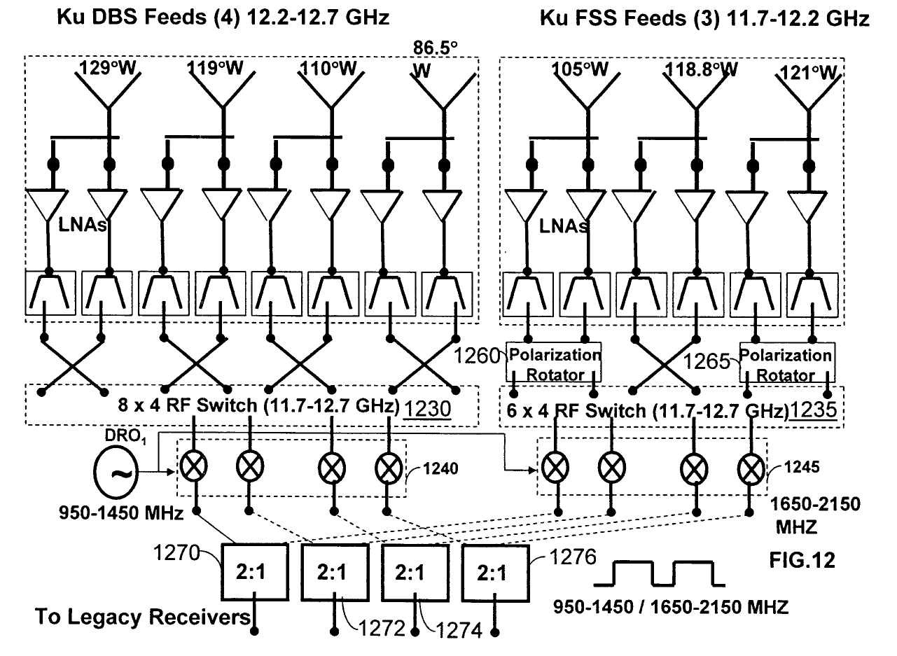

FIG. 12 is a system block diagram for an expanded Ku BSS/Ku FSS receiving system which expands the number of Ku BSS orbital locations to four, and the number of selected Ku locations to three. For purposed of illustration, additional locations have been added at 86.5° W. for Ku BSS and 105° W, 118.8° W, 121° W for Ku FSS, although the number of slots can be expanded arbitrarily at pre-determined locations. The orbital slots selected require a fixed polarization rotator to combine the received CP signals at the 118.8° W location, but two separate adjustable polarization rotators, 1260 and 1265, for the received linear components at 105° W and 121° W. For the example shown, two separate non-blocking RF switches 1230 and 1235 (both operating from 11.7-12.2 GHZ) can be used to select the desired transponder containing the video content requested by four independent IRDs. A single local oscillator (DRO₁) with separate mixer assemblies 1240 and 1245 can be used to produce the four IF outputs in the 950-1450 MHz, and 1650-2150 MHz frequency bands. Then, IF switches 1270-1276 may be used to select four signals from the eight outputs of the mixer assemblies. These four signals can be sent to legacy receivers. Legacy receivers have the ability to process “stacked” Ku video signals presented in this IF band, so it is a convenient choice although other IF bands could be selected.

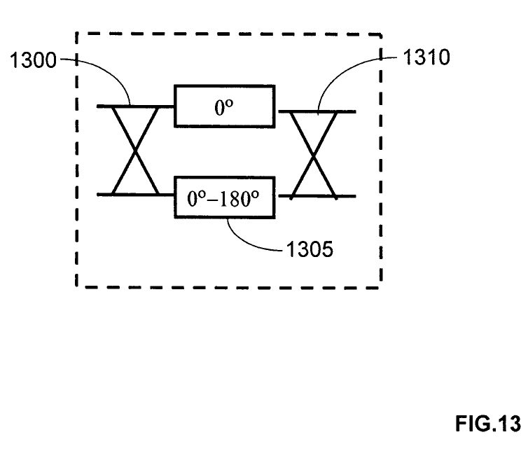

The adjustable polarization rotator module is illustrated in FIG. 13, although other configurations (such as variable gain amplifiers) producing the same output ratios can also be employed. In FIG. 13, a first hybrid 1300 receives vertically and horizontally linearly polarized signals and outputs a left and right-hand circularly polarized signals. One part of the signal (either LHCP or RHCP) is transferred with zero shift, while the other undergoes a phase shift (1305) of 0°-180°. The two signals are then passed through another hybrid 1310, so that the output is two orthogonal linearly polarized signals that are rotated with respect to the input V and H signals.

### An Embodiment for Digital Ku BSS/Ka FSS Architecture

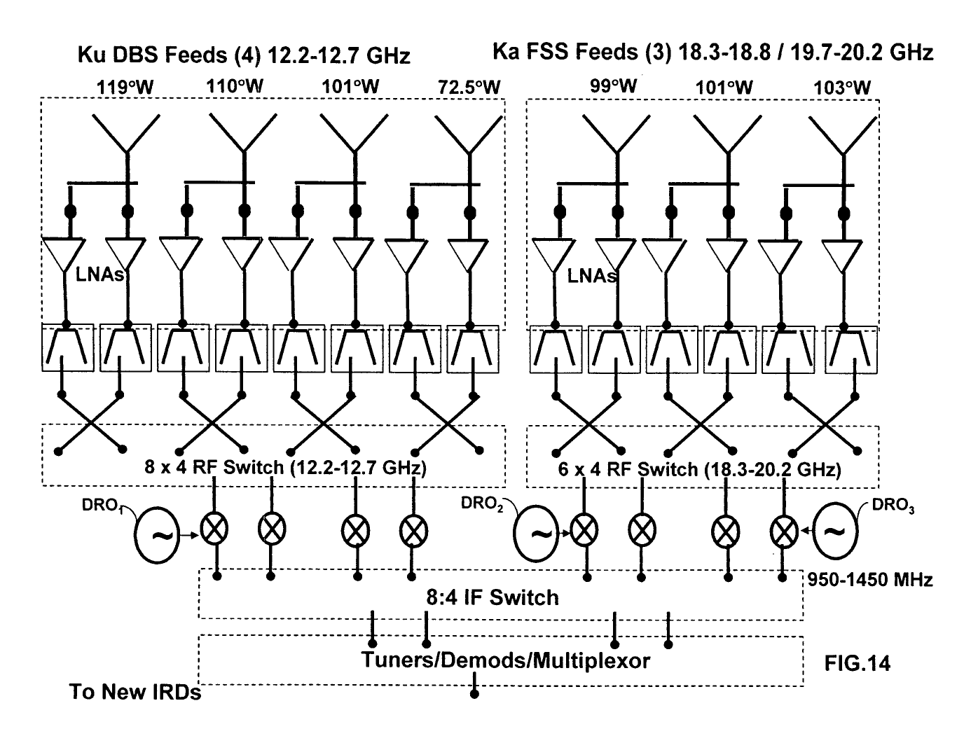

FIG. 14 illustrates an alternative embodiment for an expanded Ku BSS/Ka FSS system employing a single wire digital interface. In this example all downconverted IF signals are generated at 950-1450 MHz, and are selected for inputs into four independent IRDs in a single coaxial cable or twisted pair. Since all of the signals must be downconversted to the same bandwidth, three different oscillators are required, here ORD₁ for converting the 12.2-12.7 GHz, ORD₂ for converting the 18.3-18.8 GHZ, and ORD₃ for converting the 19.7-20.2 GHz signals to 950-1450 MHz.

### An Embodiment for Digital Ku BSS/Ku FSS Architecture

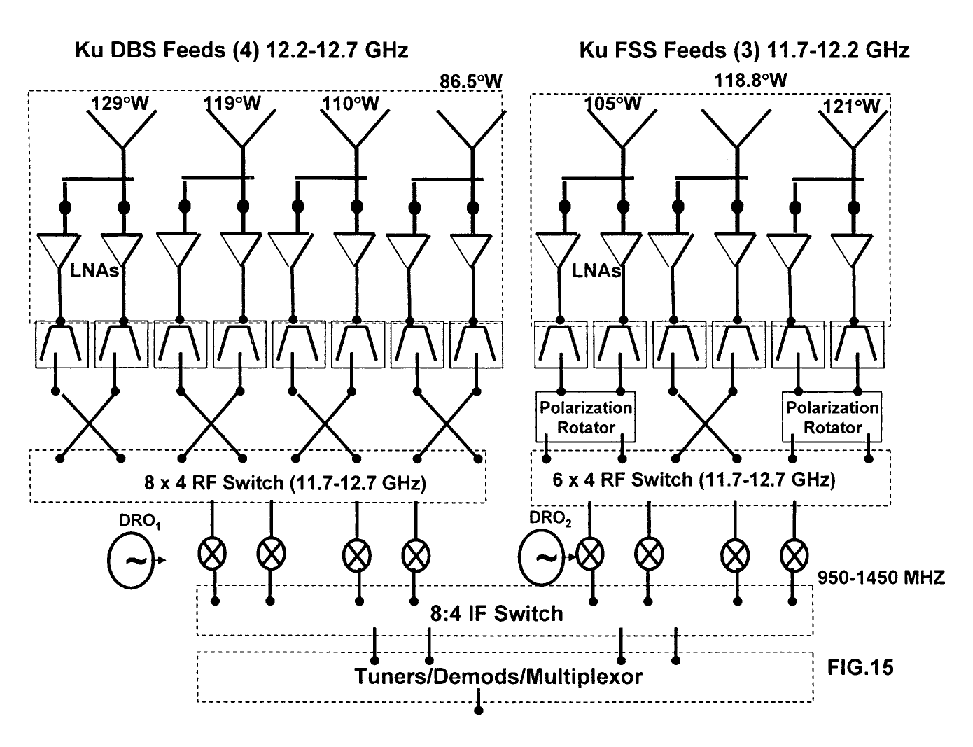

FIG. 15 illustrates an alternative embodiment for an expanded Ku BSS/Ku FSS system employing a single wire digital interface. In this example all downconverted IF signals are generated at 950-1450 MHz, and are selected for inputs into four independent IRDs in a single coaxial cable or twisted pair.

The foregoing description has been presented for purposed of illustration and is not intended to be exhaustive or limit the invention to the precise form disclosed. In light of the above teaching, the following advantages may include, without limitation:

(1) The number of orbital positions accessible to the integrated multibeam receiving system can be arbitrarily expanded beyond the limitations of the prior art by adding low-cost feed elements and low noise amplifiers, of which outputs are selected by an RF switch configuration based on the number of receiving IRDs in the home. The front end assembly preceding the LNBs and tuners can accommodate a variety of orbital slots with different operating frequencies, bandwidths, and polarizations from any Ku BSS, Ku FSS, Ka FSS, or Ku BSS satellite. Additional feeds can be installed in the assembly to anticipate the future use of a new orbital location, without the need for antenna/ODU replacement and/or rewiring.
(2) The antenna feed elements may be based on either linear or circularly polarized feed elements, and provision is made within the ODU to process the desired polarization. This feature allows the antenna feed elements to be based on all linearly polarized radiators, or circularly polarized radiators, as desired.
(3) The non-blocking rf switch greatly simplifies the LNB assembly required in terms of numbers of downconverters, mixers, and IF amplifiers, and eliminates the need for an IF multiswitch.
(4) The IF interface can be compatible with legacy receivers with various IF frequency “stacking” plans.
(5) The digital option allows for common type IF signal processing elements (all operating at 950-1450 MHz, for example) which greatly simplifies the installation and wiring into the home.
(6) The system has the capability to operate with multiple Ku FSS satellites, and adjust the polarization across the geostationary arc as the appropriate satellite is selected.

1. An integrated multibeam antenna receiving system capable of receiving signals from a plurality of satellites and serving a plurality of Integrated Receiver-Decoder (IRDs), comprising:
a plurality feed elements, each capable of receiving signals from one of the satellites;
an RF switch comprising a plurality of inputs coupled to the plurality of feed elements, and a plurality of outputs of total number equal to the number of the plurality of IRDs, each input of the switch representing a possible feed selection, and the outputs representing selected transponder outputs requested by the IRDs; and,
a low noise block (LNB) assembly receiving signals from the RF switch and providing IF signals in the desired frequency ranges.

2. The antenna receiving system of claim 1, further comprising a plurality of low noise RF amplifiers interposed between the plurality of feed elements and the RF switch and each having an input coupled to a corresponding one of the feed elements.

3. The antenna receiving system of claim 2, further comprising a plurality of filters interposed between the plurality of low noise RF amplifiers and the RF switch.

4. The antenna receiving system of claim 3, wherein each of the filters comprises an input coupled to an output of a corresponding one of the RF amplifiers.

5. The antenna receiving system of claim 2, further comprising a plurality of polarization processing modules interposed between the plurality of low noise RF amplifiers and the RF switch.

6. The antenna receiving system of claim 5, further comprising a plurality of filters, wherein each of the filters comprises an input coupled to an output of a corresponding polarization processing module.

7. The antenna receiving system of claim 4, further comprising a plurality of polarization processing modules interposed between the plurality of low noise RF amplifiers and the RF switch.

8. The antenna receiving system of claim 4, further comprising a plurality of polarization processing modules, each comprising inputs coupled to respective filters.

9. The antenna receiving system of claim 1, wherein the RF switch comprises a plurality of inputs of total number equal to twice the number of the plurality of feed elements.

10. The antenna receiving system of claim 1, further comprising an IF switch having inputs coupled to outputs of the RF switch.

11. The antenna receiving system of claim 10, further comprising a multiplexing assembly having inputs coupled to the IF switch and providing a single multiplexed output.

12. The antenna receiving system of claim 5, wherein at least one of the polarization processing modules comprises a variable polarization rotation module.

13. The antenna receiving system of claim 7, wherein at least one of the polarization processing modules comprises a variable polarization rotation module.

14. The antenna receiving system of claim 1, wherein the RF switch comprises a non-blocking RF switch.

15. The antenna receiving system of claim 5, wherein at least one of the feed elements comprises a circularly polarized feed element.

16. The antenna receiving system of claim 15, wherein at least one of the feed elements comprises a linearly polarized feed element.

17. The antenna receiving system of claim 5, wherein at least one of the feed elements comprises a dual polarized feed element.
